(19) United States
(12) Patent Application Publication
(10) Pub. No.: US 2015/0171420 A1
(43) Pub. Date: Jun. 18, 2015

(54) NEGATIVE ELECTRODE ACTIVE MATERIAL, METHOD FOR MANUFACTURING THE SAME, AND LITHIUM RECHARGABLE BATTERY INCLUDING THE SAME

(71) Applicants: SEJIN INNOTECH CO., LTD, Ulsan (KR); UNIST Academy-Industry Research Corporation, Ulsan (KR)

(72) Inventors: Soojin PARK, Ulsan (KR); Sang-Young Lee, Busan (KR); Seung Hee Ko, Jeju-si (KR); Jung-In Lee, Gunpo-si (KR); Jang-Hoon Park, Gunpo-si (KR); Han Ho Lee, Seoul (KR); Ji Hyun Yoon, Ulsan (KR); Byoung Man Bang, Gyeongsan-si (KR); Chang Rae Lee, Ulsan (KR); Il Kyo Jeong, Ulsan (KR)

(73) Assignees: SEJIN INNOTECH CO., LTD., Ulsan (KR); UNIST Academy-Industry Research Corporation, Ulsan (KR)

(21) Appl. No.: 14/227,028

(22) Filed: Mar. 27, 2014

(30) Foreign Application Priority Data
Dec. 12, 2013 (KR) 10-2013-0154825

(51) Int. Cl. H01M 4/36; H01M 4/485; H01M 4/04; H01M 4/587

(52) U.S. Cl. CPC H01M 4/366; H01M 4/587; H01M 4/485; H01M 4/0416

(57) ABSTRACT

Disclosed are a negative active material for a rechargeable lithium battery including a core including a material being capable of intercalating and deintercalating lithium ions and a shell positioned on the surface of the core, wherein the shell includes antimony-doped tin oxide, a method of manufacturing the same, and a rechargeable lithium battery including the same.

### CROSS-REFERENCE TO RELATED APPLICATION

This application claims priority to and the benefit of Korean Patent Application No. 10-2013-0154825 filed in the Korean Intellectual Property Office on Dec. 12, 2013, the entire contents of which are incorporated herein by reference.

### BACKGROUND OF THE INVENTION

(a) Field of the Invention

A negative active material for a rechargeable lithium battery, a method of manufacturing the same, and a rechargeable lithium battery including the same are disclosed.

(b) Description of the Related Art

A rechargeable lithium battery has garnered attention as a power source for operating an electronic device. The rechargeable lithium battery has mainly used graphite as a negative electrode material, but graphite has small capacity of about 372 mAh/g per unit mass, and thus may hardly accomplish high capacity of the rechargeable lithium battery.

A negative electrode material realizing higher capacity than the graphite may include a material formed of a compound of lithium and a metal, for example, silicon, tin, an oxide thereof, and the like. In particular, the material such as silicon and the like may realize high capacity and downsizing of a battery.

However, these materials undergo a crystal structure change when lithium is absorbed and stored, and thus a problem of volume expansion occurs. The silicon undergoes volume expansion of up to about 4.12 times the volume of the silicon before the expansion. Accordingly, the silicon has a problem of sharply deteriorating a battery cycle-life.

Therefore, research on a solution to the problem of these carbon-based and non-carbon-based negative active materials has been actively made.

### SUMMARY OF THE INVENTION

One embodiment of the present invention provides a negative active material for a rechargeable lithium battery with increased storage capacity of lithium ions, having excellent electrical conductivity, and realizing stable cycle and high power characteristics, a method of manufacturing the same, and a rechargeable lithium battery including the same.

In one embodiment of the present invention, a negative active material for a rechargeable lithium battery includes a core including a material being capable of intercalating and deintercalating lithium ions and a shell positioned on the surface of the core, wherein the shell includes antimony-doped tin oxide.

The antimony-doped tin oxide may be coated with carbon. The antimony-doped tin oxide may not be coated with carbon.

The shell may further include carbon. Specifically, the shell may further include amorphous carbon.

The shell may include a first shell including the antimony-doped tin oxide and a second shell including carbon.

The shell may have a thickness of about 10 nm to about 500 nm.

The shell may be included in an amount of about 5 to about 25 wt % based on the total amount of the negative active material.

The material being capable of intercalating and deintercalating lithium ions may include a carbon-based material, an alloy-based material, a metal oxide-based material, or a combination thereof.

Examples of the material being capable of intercalating and deintercalating lithium ions may include natural graphite, artificial graphite, soft carbon, hard carbon, carbon fiber, carbon nanotubes, carbon nanofiber, graphene, or a combination thereof.

As another example, the material being capable of intercalating and deintercalating lithium ions may be an alloy or an oxide of a metal selected from silicon, tin, germanium, antimony, bismuth, or a combination thereof.

In another embodiment of the present invention, a method of manufacturing a negative active material for a rechargeable lithium battery includes: preparing a material being capable of intercalating and deintercalating lithium ions; preparing a shell composition including antimony-doped tin oxide; adding the material being capable of intercalating and deintercalating lithium ions and the shell composition in a solvent to obtain a mixture; and heat-treating the mixture.

The process of preparing the material being capable of intercalating and deintercalating lithium ions may further include activating the surface of the material being capable of intercalating and deintercalating lithium ions.

The process of preparing a shell composition including antimony-doped tin oxide may further include coating the antimony-doped tin oxide with carbon.

The shell composition may include the antimony-doped tin oxide and a carbon precursor.

The carbon precursor may be, for example, sucrose, citric acid, glucose, agarose, polysaccharide, poly(vinyl pyrrolidone), polyvinyl alcohol, or a combination thereof.

The shell composition may be used in a range of about 5 to about 25 wt % based on the total amount of the negative active material for a rechargeable lithium battery.

The solvent may include water, alcohol, acetone, tetrahydrofuran, cyclohexane, carbon tetrachloride, chloroform, methylenechloride, dimethylformamide, dimethylacetamide, dimethylsulfoxide, N-methylpyrrolidone, or a combination thereof.

The heat-treating may be performed at a temperature of about 400° C. to about 700° C.

The heat-treating may be performed for about 1 hour to about 6 hours.

The heat-treating may be performed under a reduction atmosphere. In other words, the heat-treating may be performed under an inactive gas atmosphere.

Yet another embodiment of the present invention provides a rechargeable lithium battery including: the negative electrode including a negative active material; a positive electrode; and an electrolyte.

The negative active material according to one embodiment shows increased storage capacity of lithium ions and excellent electrical conductivity. A rechargeable lithium battery including the same may show high-capacity, high power, high rate capability, and stable cycle characteristics.

### BRIEF DESCRIPTION OF THE DRAWINGS

FIG. 1 is a drawing briefly showing a method of manufacturing a negative active material according to Example 1.

FIG. 2 shows scanning electron microscope photographs of the surface of negative active materials according to Examples 1 and 2.

FIG. 3 is an X-ray diffraction analysis graph showing the negative active materials according to Examples 1 and 2.

FIG. 4 shows scanning electron microscope photographs of the surface of negative active materials according to Examples 3 and 4.

FIG. 5 is an X-ray diffraction analysis graph showing the negative active materials according to Examples 3 and 4.

FIG. 6 is a scanning electron microscope photograph showing the surface of negative active materials according to Examples 5 and 6.

FIG. 7 is an X-ray diffraction analysis graph showing the negative active materials according to Examples 5.

FIG. 8 is a graph showing a voltage change depending on cycle capacity of battery cells according to Comparative Example 1 and Examples 1 to 3.

FIG. 9 is a graph showing capacity retention of the battery cells according to Comparative Example 1 and Examples 1 to 3.

FIG. 10 is a graph showing a voltage change depending on first cycle capacity of battery cells according to Comparative Example 2 and Example 5.

FIG. 11 is a graph showing capacity retention of the battery cells according to Comparative Example 2 and Example 5.

FIG. 12 is a graph showing rate charge and discharge cycle-life characteristics of the battery cells according to Comparative Example 1 and Examples 1 to 3.

### DETAILED DESCRIPTION

Hereinafter, embodiments of the present invention are described in detail. However, these embodiments are exemplary, and this disclosure is not limited thereto.

In one embodiment of the present invention, a negative active material for a rechargeable lithium battery includes a core including a material being capable of intercalating and deintercalating lithium ions, and a shell positioned on the surface of the core, wherein the shell includes antimony-doped tin oxide (ATO).

In other words, one embodiment provides a negative active material surface-modified with ATO.

The ATO reversibly reacts with lithium and thus contributes to lithium ion storage capacity and also has excellent electrical conductivity, and when the ATO is introduced on the surface of a negative active material, the negative active material may show increased lithium ion storage capacity and realize excellent cycle-life characteristics, high power characteristics, high-rate capability, and the like.

The negative active material may complement low capacity and low high-rate capability of a carbon-based negative active material as well as low electrical conductivity of a non-carbon-based negative active material, and thus satisfies high power characteristics.

The negative active material may have a shell further including carbon in addition to the ATO. The shell may include the carbon in various ways.

For example, the antimony-doped tin oxide may be coated with the carbon. In other words, the shell may include ATO coated with the carbon. As another example, the shell may have a structure in which the ATO and the carbon are mixed. The carbon included in the shell may specifically be amorphous carbon.

Otherwise, the shell may include a first shell including the ATO and a second shell including the carbon.

When the shell further includes the carbon, electrical conductivity of a negative active material is increased, and thus cycle-life and charge and discharge characteristics of a battery are improved.

The shell may have a thickness of about 10 nm to about 500 nm, specifically, about 10 nm to about 400 nm, about 10 nm to about 300 nm, about 50 nm to about 500 nm, or about 100 nm to about 500 nm. In this case, the negative active material may show high capacity, high power characteristics, and excellent cycle characteristics.

The shell may be included in an amount of about 5 to about 25 wt %, specifically about 5 to about 20 wt %, or about 10 to about 25 wt % based on the total amount of the negative active material. In this case, the negative active material may show high capacity, high power characteristics, and excellent cycle characteristics.

The material capable of intercalating and deintercalating lithium ions may include any material generally used as a negative active material for a rechargeable lithium battery.

Specifically, the material being capable of intercalating and deintercalating lithium ions may be a carbon-based material or a non-carbon-based material.

The carbon-based material may be, for example, natural graphite, artificial graphite, soft carbon, hard carbon, carbon fiber, carbon nanotubes, carbon nanofiber, graphene, or a combination thereof.

The non-carbon-based material may be an alloy-based material, a metal oxide-based material, or a combination thereof.

The alloy-based material may be an alloy or an oxide of a metal selected from silicon, tin, germanium, antimony, bismuth, or a combination thereof. The metal oxide-based material may be an oxide of a metal selected from silicon, tin, germanium, antimony, bismuth, or a combination thereof.

The non-carbon-based material may be, for example, a silicon-based material. The silicon-based material may be silicon, a silicon oxide, or a silicon-based alloy.

In another embodiment of the present invention, a method of manufacturing a negative active material for a rechargeable lithium battery includes: preparing a material being capable of intercalating and deintercalating lithium ions; preparing a shell composition including antimony-doped tin oxide; adding the material being capable of intercalating and deintercalating lithium ions and the shell composition into a solvent to obtain a mixture; and heat-treating the mixture.

The manufacturing method may provide a negative active material having a core including a material capable of intercalating and deintercalating lithium ions and a shell positioned on the surface of the core and including ATO.

The method of manufacturing a negative active material is specifically illustrated.

The method of manufacturing a negative active material for a rechargeable lithium battery may further include activating the surface of a material capable of intercalating and deintercalating lithium ions to improve reactivity of the material capable of intercalating and deintercalating lithium ions with another material after preparing the material capable of intercalating and deintercalating lithium ions.

The surface of the material capable of intercalating and deintercalating lithium ions may be activated by using an acid, a catalyst, and/or the like. For example, a solvent such as nitric acid, sulfuric acid, hydrogen peroxide, or a combination thereof may be used to activate the surface of the material capable of intercalating and deintercalating lithium ions.

The antimony-doped tin oxide may be, for example, coated with carbon. In other words, the preparation of a shell composition including the antimony-doped tin oxide may further include coating the antimony-doped tin oxide with carbon.

The coating of the antimony-doped tin oxide with carbon may include mixing the antimony-doped tin oxide and a carbon precursor with a solvent, drying the mixture, and heat-treating it.

The carbon precursor may include, for example, citric acid, poly(vinyl pyrrolidone), polyvinyl alcohol, glucose, sucrose, and the like, but any material carbonized through a heat treatment may be without a particular limit.

The solvent may be water; alcohols such as ethanol, methanol, and the like; or a polar solvent such as tetrahydrofuran, N-methylpyrrolidone, N,N-dimethylformamide, and the like; or a combination thereof.

During the coating of the antimony-doped tin oxide with carbon, the carbon precursor may be included at about 1 to 10 times parts by mass more than the amount of the ATO.

During the coating of the antimony-doped tin oxide with carbon, the heat-treating may be performed under an inert gas atmosphere, and a temperature in the heat-treating may be gradually increased to a point that the carbon precursor is carbonized.

According to another embodiment, the shell composition may further include carbon or a carbon precursor other than the ATO. In other words, the shell composition may include the antimony-doped tin oxide and the carbon precursor. The shell composition including the ATO and the carbon precursor and the material capable of intercalating and deintercalating lithium ions are mixed with a solvent, and the mixture is fired to manufacture the ATO coated with carbon as a negative active material.

The carbon precursor may be, for example, sucrose, citric acid, glucose, agarose, polysaccharide, poly(vinyl pyrrolidone), polyvinyl alcohol, or a combination thereof.

Herein, the coated carbon may be amorphous carbon. The shell composition may be included in an amount of about 5 to about 25 wt %, specifically about 5 to about 20 wt %, and more specifically about 10 to about 25 wt % based on the total amount of the negative active material for a rechargeable lithium battery. This negative active material may show high capacity, high power characteristics, and excellent cycle characteristics.

The solvent may be water, alcohol, acetone, tetrahydrofuran, cyclohexane, carbon tetrachloride, chloroform, methylenechloride, dimethylformamide, dimethylacetamide, dimethylsulfoxide, N-methylpyrrolidone, or a combination thereof.

The heat-treating may be performed at about 400° C. to about 700° C., and specifically about 400° C. to about 600° C.

The heat-treating may provide a negative active material having a core including a material capable of intercalating and deintercalating lithium ions and a shell including ATO on the core.

The heat-treating may be performed for about 1 hour to about 6 hours, specifically for about 2 hours to about 6 hours, and more specifically for about 3 hours to about 6 hours.

In addition, the heat-treating may be performed under a reduction atmosphere. The reduction atmosphere may include an inert gas atmosphere such as argon and the like or a vacuum atmosphere.

On the other hand, the method of manufacturing a negative active material may further include drying the mixture to remove the solvent therein before the heat-treating.

In another embodiment of the present invention, a negative electrode including the negative active material is provided. The negative electrode includes a current collector and a negative active material layer formed on the current collector, and the negative active material layer includes a negative active material.

The negative active material layer may further include a binder and/or a conductive material.

The binder may attach negative active material particles to each other, and also negative active materials to a current collector. The binder may be a non-water-soluble binder, a water-soluble binder, or a combination thereof.

The non-water-soluble binder may be polyvinylchloride, carboxylated polyvinylchloride, polyvinylfluoride, an ethylene oxide-containing polymer, poly(vinyl pyrrolidone), polyurethane, polytetrafluoroethylene, polyvinylidene fluoride, polyethylene, polypropylene, polyamideimide, polyimide, or a combination thereof.

The water-soluble binder may be a styrene-butadiene rubber, an acrylated styrene-butadiene rubber, polyvinyl alcohol, sodium polyacrylate, a copolymer of propylene and a C2 to C8 olefin, a copolymer of (meth)acrylic acid and (meth)acrylic acid alkyl ester, or a combination thereof.

The conductive material improves conductivity of an electrode. Any electrically conductive material may be used as a conductive material, unless it causes a chemical change. Examples thereof may be a carbon-based material such as natural graphite, artificial graphite, carbon black, acetylene black, ketjen black, a carbon fiber, and the like; a metal-based material such as a metal powder, a metal fiber, and the like of copper, nickel, aluminum, silver, and the like; a conductive polymer such as a polyphenylene derivative and the like; or a mixture thereof.

The current collector may be selected from a copper foil, a nickel foil, a stainless steel foil, a titanium foil, a nickel foam, a copper foam, a polymer substrate coated with a conductive metal, and a combination thereof.

In another embodiment of the present invention, a rechargeable lithium battery including the above negative electrode and a positive electrode is provided.

The positive electrode may include a positive current collector and a positive active material layer formed on the positive current collector. The positive active material may include lithiated intercalation compounds that reversibly intercalate and deintercalate lithium ions. Specifically, cobalt, a composite oxide including at least one of cobalt, manganese, nickel, or a combination thereof, as well as lithium may be used. More specific examples may be compounds represented by the following chemical formulae.

LiₐA_{1-b}X_{b}D₂ (0.90≦a≦1.8, 0≦b≦0.5); LiₐA_{1-b}X_{b}O_{2-c}D_{c} (0.90≦a≦1.8, 0≦b≦0.5, 0≦c≦0.05); LiE_{1-b}X_{b}O_{2-c}D_{c} (0≦b≦0.5, 0≦c≦0.05); LiE_{2-b}X_{b}O_{4-c}D_{c} (0≦b≦0.5, 0≦c≦0.05); LiₐNi_{1-b-c}Co_{b}X_{c}D_{α} (0.90≦a≦1.8, 0≦b≦0.5, 0≦c≦0.05, 0<α≦2); LiₐNi_{1-b-c}Co_{b}X_{c}O_{2-α}T_{α} (0.90≦a≦1.8, 0≦b≦0.5, 0≦c≦0.05, 0<α<2); LiₐNi_{1-b-c}Co_{b}X_{c}O_{2-α}T₂ (0.90≦a≦1.8, 0≦b≦0.5, 0≦c≦0.05, 0<α<2); LiₐNi_{1-b-c}Mn_{b}X_{c}D_{α} (0.90≦a≦1.8, 0≦b≦0.5, 0≦c≦0.05, 0<α≦2); LiₐNi_{1-b-c}Mn_{b}X_{c}O_{2-α}T_{α} (0.90≦a≦1.8, 0≦b≦0.5, 0≦c≦0.05, 0<α<2); LiₐNi_{1-b-c}Mn_{b}X_{c}O_{2-α}T₂ (0.90≦a≦1.8, 0≦b≦0.5, 0≦c≦0.05, 0<α<2); LiₐNi_{b}E_{c}G_{d}O₂ (0.90≦a≦1.8, 0≦b≦0.9, 0≦c≦0.5, 0.001≦d≦0.1); LiₐNi_{b}Co_{c}Mn_{d}GₑO₂ (0.90≦a≦1.8, 0≦b≦0.9, 0≦c≦0.5, 0≦d≦0.5, 0.001≦e≦0.1); LiₐNiG_{b}O₂ (0.90≦a≦1.8, 0.001≦b≦0.1); LiₐCoG_{b}O₂ (0.90≦a≦1.8, 0.001≦b≦0.1); LiₐMnG_{b}O₂ (0.90≦a≦1.8, 0.001≦b≦0.1); LiₐMn₂G_{b}O₄ (0.90≦a≦1.8, 0.001≦b≦0.1); LiₐMnG_{b}PO₄ (0.90≦a≦1.8, 0.001≦b≦0.1); QO₂; QS₂; LiQS₂; V₂O₅; LiV₂O₅; LiZO₂; LiNiVO₄; Li_{(3-f)}J₂(PO₄)₃ (0≦f≦2); Li_{(3-f)}Fe₂(PO₄)₃ (0≦f≦2); LiFePO₄.

In the above chemical formulae, A is selected from Ni, Co, Mn, and a combination thereof; X is selected from Al, Ni, Co, Mn, Cr, Fe, Mg, Sr, V, a rare earth element, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The compounds may have a coating layer on the surface, or may be mixed with another compound having a coating layer. The coating layer may include at least one coating element compound selected from the group consisting of an oxide of a coating element, a hydroxide of a coating element, an oxyhydroxide of a coating element, an oxycarbonate of a coating element, and a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed in a method having no adverse influence on properties of a positive active material by using these elements in the compound. For example, the method may include any coating method such as spray coating, dipping, and the like, but is not illustrated in more detail since it is well-known to those who work in the related field.

The positive active material layer may also include a binder and a conductive material.

The binder improves binding properties of positive active material particles with one another and with a current collector, and examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, poly(vinyl pyrrolidone), polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material improves conductivity of an electrode. Any electrically conductive material may be used as a conductive material, unless it causes a chemical change. Examples thereof may be one or more of natural graphite, artificial graphite, carbon black, acetylene black, ketjen black, a carbon fiber, a metal powder, a metal fiber and the like of copper, nickel, aluminum, silver, and the like, or a conductive material such as a polyphenylene derivative and the like.

The current collector may be Al, but is not limited thereto.

The negative electrode and positive electrode may be respectively manufactured by a method including mixing an active material, a conductive material, and a binder into an active material composition and coating the composition on a current collector. The electrode manufacturing method is well known, and thus is not described in detail in the present specification. The solvent includes N-methylpyrrolidone and the like, but is not limited thereto.

In a non-aqueous electrolyte rechargeable battery according to one embodiment the present invention, a non-aqueous electrolyte includes a non-aqueous organic solvent and a lithium salt.

The non-aqueous organic solvent serves as a medium for transmitting ions taking part in the electrochemical reaction of a battery.

A separator may be present between the positive electrode and negative electrode according to kinds of a rechargeable lithium battery. The separator may be polyethylene, polypropylene, polyvinylidene fluoride, or a multi-layer thereof, for example a polyethylene/polypropylene double-layered separator, a polyethylene/polypropylene/polyethylene triple-layered separator, a polypropylene/polyethylene/polypropylene triple-layered separator, and the like. Hereinafter, examples of the present invention and comparative examples are described. These examples, however, are not in any sense to be interpreted as limiting the scope of the invention.

### Example 1

### Manufacture of Negative Active Material

Natural graphite, a carbon-based material, was used for a core, and ATO coated with carbon was used for a shell.

The surface of the natural graphite was activated to improve reactivity of a different material from the natural graphite. The natural graphite was put in a solvent consisting of nitric acid, sulfuric acid, hydrogen peroxide, or a combination thereof in a container, and the mixture was agitated for greater than or equal to 30 minutes with an agitator. After the agitation, the natural graphite was separated by using a centrifuge, and the solvent remaining therein was dried in a vacuum oven.

The coating of the ATO with the carbon is performed as follows. About 1 to 10 parts by mass of a carbon precursor such as citric acid, poly(vinyl pyrrolidone), and the like was added to an aqueous solution in which about 30 mass % of the ATO was dispersed. The mixture was agitated and reacted to uniformly form a shell on the surface of the ATO. After the sufficient agitation, a solvent remaining therein was removed, and the remaining reactant was heat-treated under an inert atmosphere. The temperature for the heat-treating was gradually increased until the carbon precursor was carbonized.

The carbon-coated ATO was dispersed to be about 30 wt % of a concentration in a methanol solvent.

0.5 g of the carbon-coated ATO solution (0.15 g of the ATO) was mixed with 1.5 g of surface-activated natural graphite. The mixture was agitated and reacted to uniformly form a shell layer on the surface of the natural graphite.

After the sufficient agitation, an organic solvent remaining therein was removed, and the remaining reactant was heat-treated under an argon atmosphere. The heat-treating was performed by gradually increasing the temperature up to 450° C. to stably maintain the ATO on the surface of the natural graphite.

In this way, a negative active material for a rechargeable lithium battery having the carbon-coated ATO as a shell on the surface of the natural graphite surface was manufactured.

The amount of the ATO may be easily adjusted by controlling the concentration of the ATO solution.

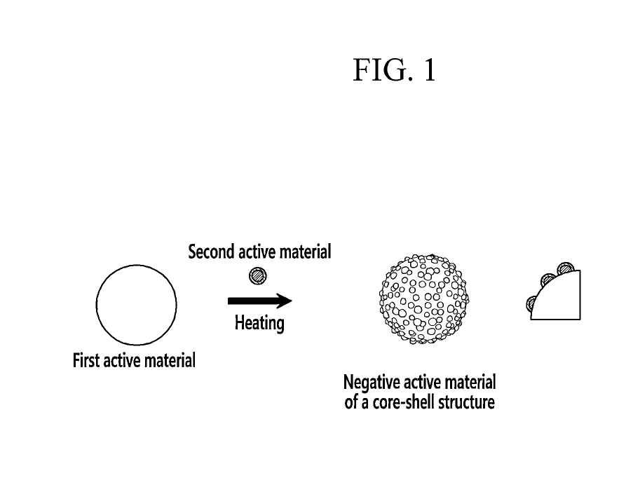

FIG. 1 is a drawing briefly showing a method of manufacturing the negative active material according to Example 1.

(Manufacture of Half Cell)

A negative active material slurry was prepared by mixing the powder as a negative active material, Super P as a conductive material, a mixture of poly(acrylic acid) (PAA)/carboxymethyl cellulose sodium salt (CMC) in a weight ratio of 90:2:8 as a binder, and water as a solvent.

The negative active material slurry was uniformly coated on a copper foil and vacuum-dried in a 90° C. convection oven for 10 minutes and in a 150° C. vacuum oven for 2 hours, manufacturing a negative electrode.

A lithium metal foil as a counter electrode was placed in a glove box under an argon atmosphere including less than or equal to 2 ppm of moisture, and polypropylene (PP) was used as a separation membrane. An electrolyte was prepared by mixing 1.3 mol of LiPF₆/EC:DEC (volume ratio of 3:7) including 10 wt % of FEC as an additive, manufacturing a coin cell.

### Example 2

A negative active material and a battery cell were manufactured according to the same method as Preparation Example 1, except for adjusting a ratio of the natural graphite and the shell to be 20:1 by using 0.25 g of a carbon-coated ATO solution (0.075 g of ATO).

### Example 3

### Manufacture of Negative Active Material

Example 3 adopts firing after simultaneously mixing a core material, ATO, and a carbon-based precursor. The surface of the natural graphite was activated as provided in Example 1. 1.5 g of the activated graphite and 0.5 g of an ATO solution (0.15 g of ATO) dispersed in methanol, and 0.75 g of citric acid were sufficiently mixed for 2 to 3 hours.

The mixture was dried at 80° C. to remove the methanol remaining therein, and then heat-treated in a 450° C. argon atmosphere for 5 hours. After the heat-treating, a negative active material having an ATO and carbon layer on the surface of the graphite surface was manufactured.

Herein, a material capable of being carbonized in an inert atmosphere during heat-treating is citric acid, but poly(vinyl pyrrolidone), poly(vinyl alcohol), glucose, sucrose, and the like may be used instead of citric acid.

(Manufacture of Half Cell)

Hereinafter, a half-cell is manufactured according to the same method as Example 1.

### Example 4

A negative active material and a battery cell were manufactured according to the same method as Example 3, except for adjusting a ratio between the natural graphite and the shell to be 20:1 by using 0.25 g of a carbon-coated ATO solution (0.075 g of ATO).

### Example 5

### Manufacture of Negative Active Material

Example 5 uses a method of introducing ATO as a shell into a silicon-based active material.

1.5 g of silicon, 0.5 g of an ATO solution dispersed in methanol (0.15 g of ATO), and 0.75 g of polyvinyl pyrrolidone were sufficiently mixed for 2 to 3 hours. The mixture was dried at 80° C. to remove methanol remaining therein, and then heat-treated at 450° C. under an argon atmosphere for 5 hours. After the heat-treating, a negative active material having an ATO and carbon layer on the surface of silicon was manufactured.

(Manufacture of Half Cell)

Hereinafter, a half-cell was manufactured according to the same method as Example 1.

### Example 6

A negative active material and a battery cell were manufactured according to the same method as Example 5, except for adjusting a ratio between the natural graphite and the shell to be 20:1 by using 0.25 g of a carbon-coated ATO solution (0.075 g of ATO).

### Comparative Example 1

A battery cell was manufactured according to the same method as Example 1, except for using natural graphite without any treatment as a positive active material.

### Comparative Example 2

A battery cell was manufactured according to the same method as

Example 1, except for using silicon nanoparticles without any treatment as a positive active material.

### Evaluation Example 1

### Surface Scanning Electron Microscope Photograph

A scanning electron microscope (SEM) was used to examine the surface of the negative active materials according to Examples 1 to 6.

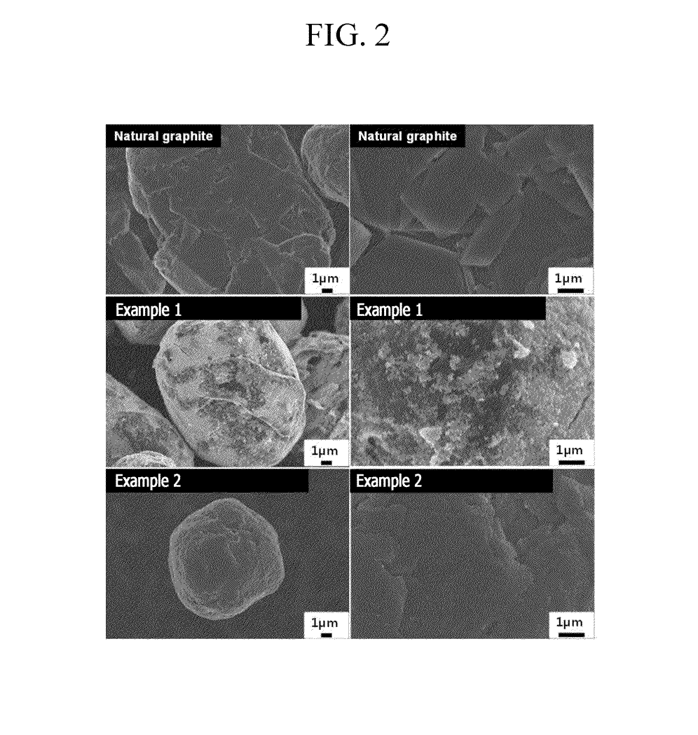

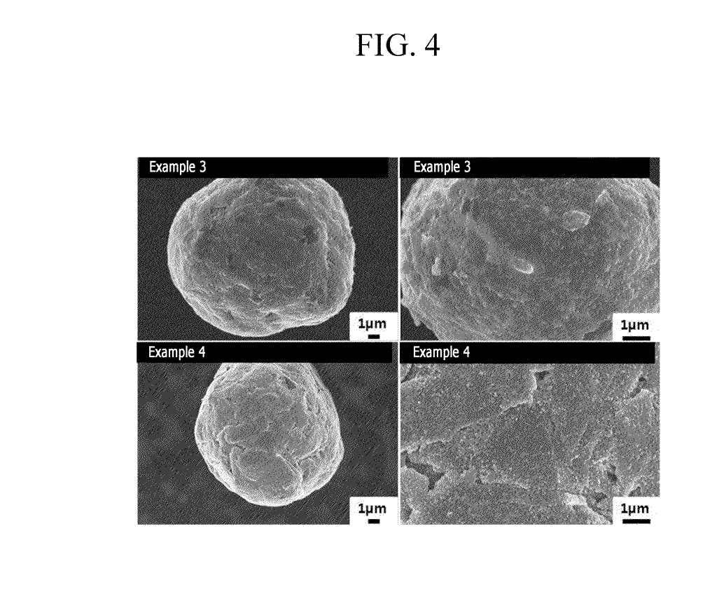

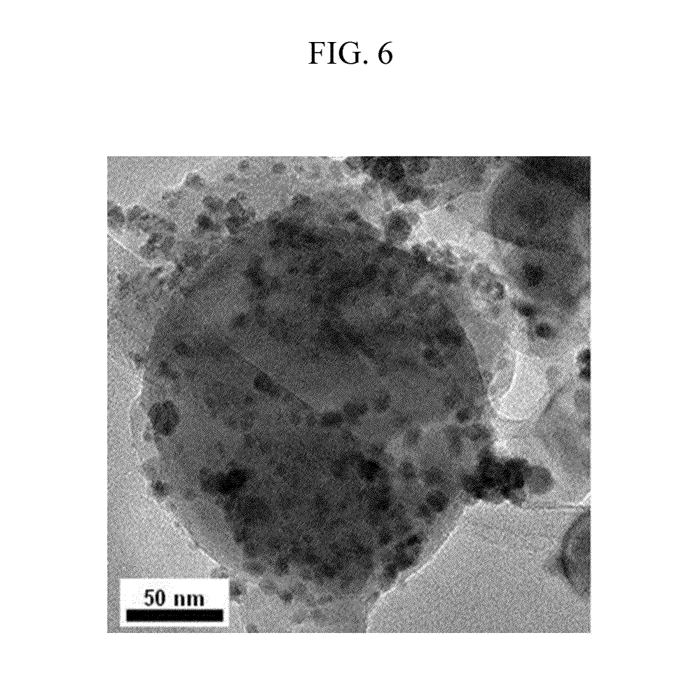

FIG. 2 shows photographs of Examples 1 and 2, FIG. 4 shows photographs of Examples 3 and 4, and FIG. 6 shows photographs of Examples and 6.

### Evaluation Example 2

### X-ray Diffraction Analysis

X-ray diffraction analysis (XRD) of the negative active materials according to Examples 1 to 6 was performed for a qualitative/quantitative analysis.

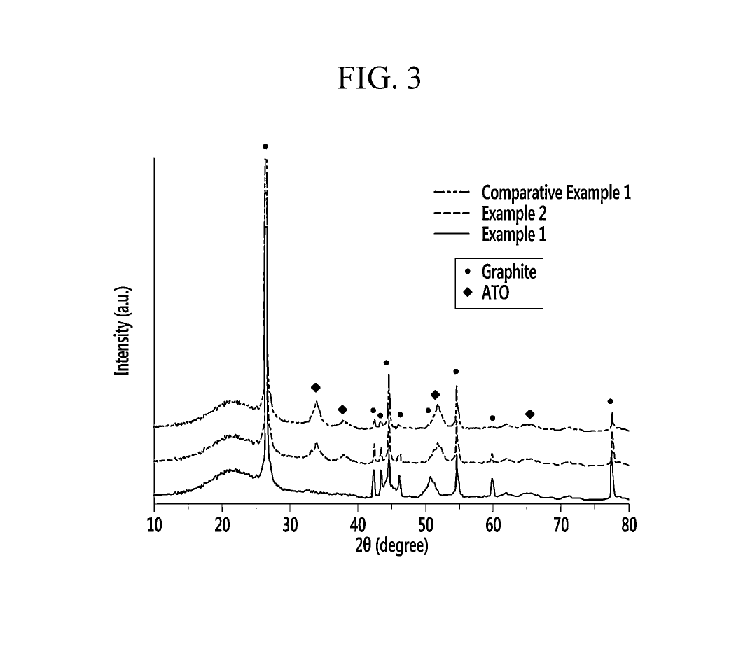

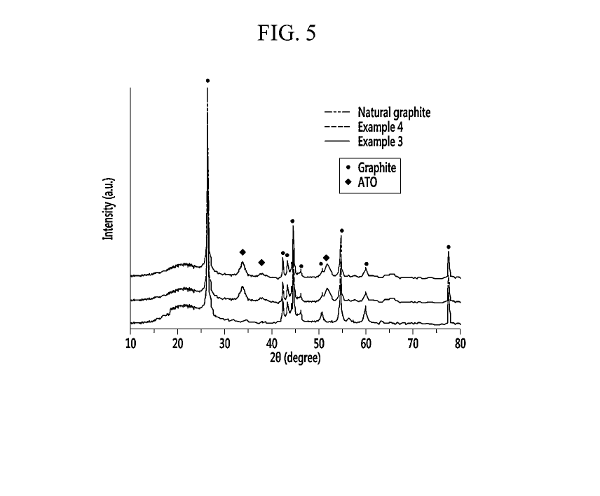

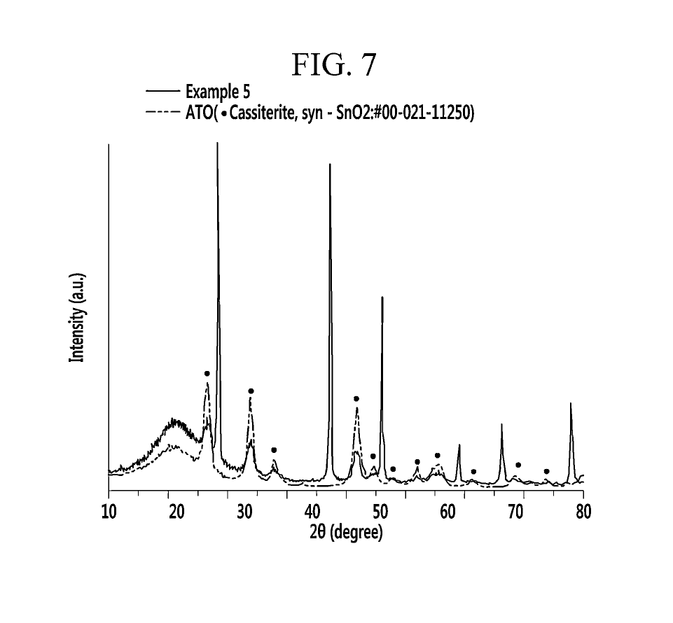

The results of Examples 1 and 2 are provided in FIG. 3, the results of Examples 3 and 4 are provided in FIG. 5, and the results of Examples 5 and 6 are provided in FIG. 7.

### Evaluation Example 3

### Charge and Discharge Cycle-Life Characteristics

A constant current experiment regarding the coin cells according to Comparative Example 1 and Examples 1 to 3 was performed at 25° C. by using a charge and discharge apparatus capable of controlling a constant current/a positive potential.

Herein, a constant current applied to the coin cells corresponds to a C/5 (lithiation, charge)-C/5 (delithiation, discharge) rate of capacity of a coin cell manufactured by using natural graphite having ATO as a shell, and a discharge (delithiation) cut-off voltage and a charge (lithiation) cut-off voltage were respectively fixed to be 3.0 V (vs. Li/Li+) and 0.005 V (vs. Li/Li+).

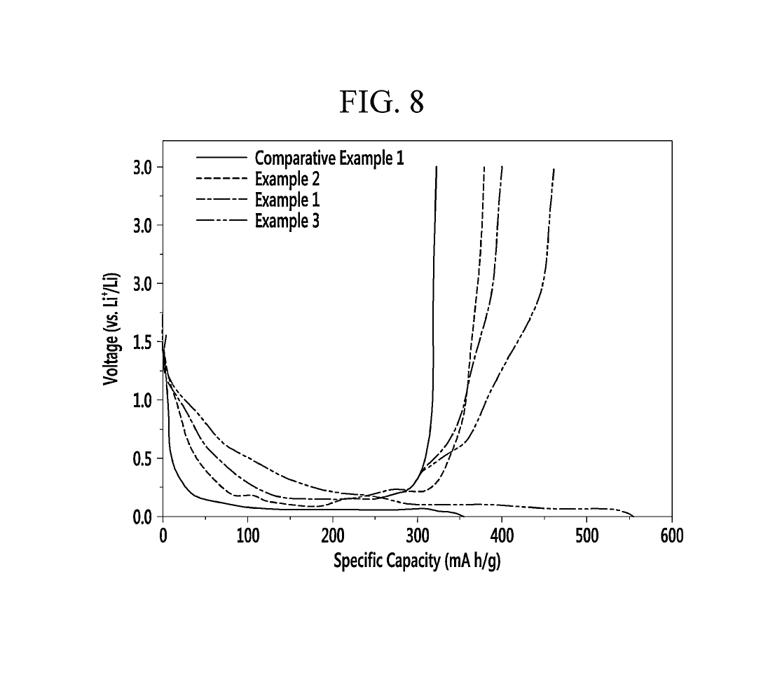

FIG. 8 is a graph showing a voltage change depending on cycle capacity of the coin cells according to Comparative Example 1 and Examples 1 to 3.

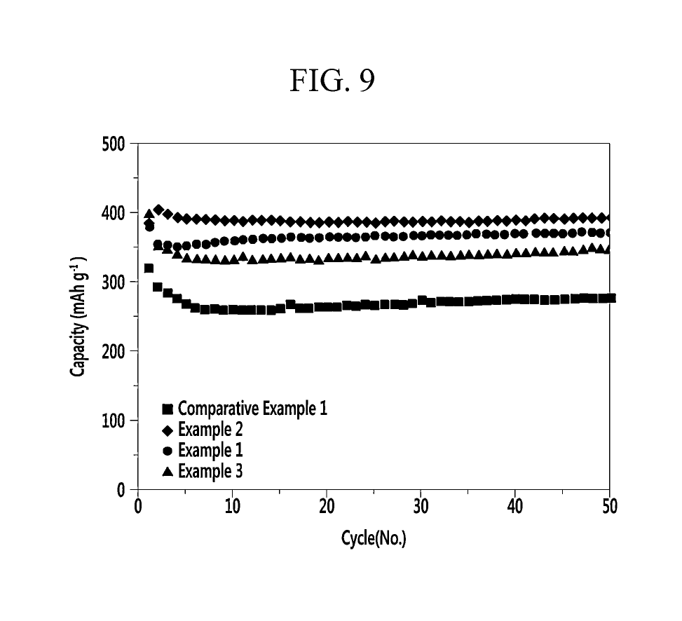

FIG. 9 is a capacity retention graph showing the cells according to Comparative Example 1 and Examples 1 to 3.

When the cells were charged and discharged 50 times, the cell of Comparative Example 1 having no shell maintained initial capacity of less than 360 mAh/g, while the cells of Examples 1 to 3 showed better initial capacity than Comparative Example 1, and herein, the natural graphite having 15% of ATO as a shell based on the natural graphite maintained capacity of greater than or equal to 400 mAh/g.

As a result, a natural graphite negative active material having ATO as a shell showed excellent capacity compared with a negative active material not modified into a core-shell structure.

### Evaluation Example 4

### Charge and Discharge Cycle-Life Characteristics

A constant current experiment regarding the cells according to Comparative Example 2 and Example 5 was performed.

Herein, a constant current applied to the coin cells corresponds to a C/2 (lithiation, charge)-C/2 (delithiation, discharge) rate of capacity of a coin cell manufactured by using silicon having ATO as a shell, and a discharge (delithiation) cut-off voltage and a charge (lithiation) cut-off voltage were respectively fixed to be 1.2 V (vs. Li/Li+) and 0.01V (vs. Li/Li+).

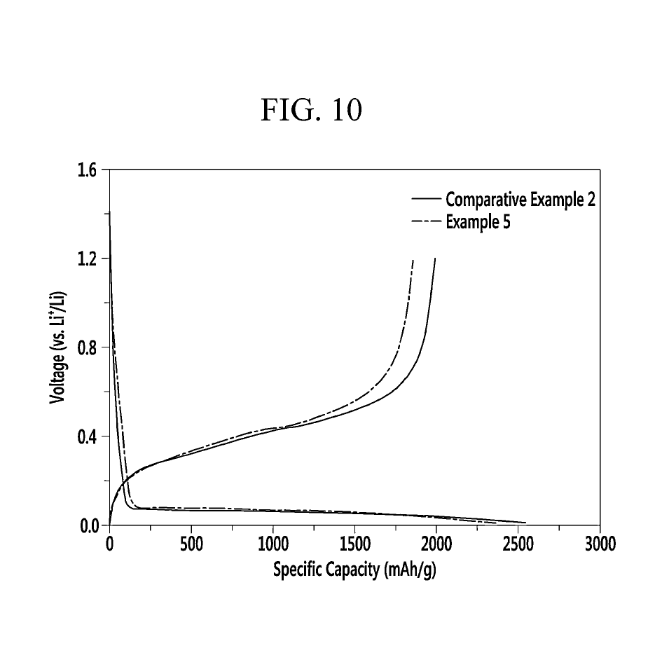

FIG. 10 is a graph showing a voltage change depending on initial cycle capacity of Comparative Example 2 and Example 5.

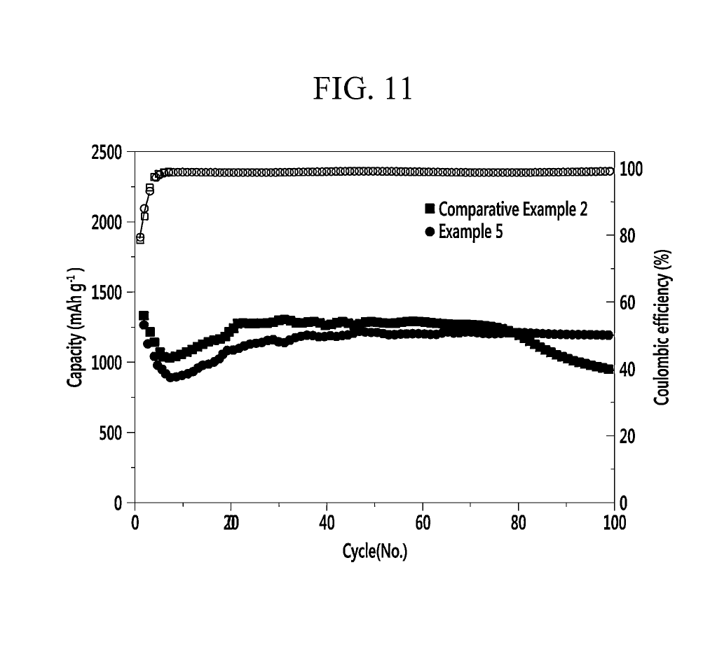

FIG. 11 is a graph showing capacity retention of Comparative Example 2 and Example 5.

When the cells were charged and discharged 100 times, the silicon negative active material having ATO as a shell (Example 5) maintained capacity of greater than or equal to 1200 mAh/g. However, the silicon negative active material of Comparative Example 2 having no ATO as a shell showed deteriorated capacity of 900 mAh/g.

As a result, a silicon negative active material having ATO as a shell showed excellent capacity or cycle-life characteristics compared with a negative active material not modified into a core-shell structure.

### Evaluation Example 5

### Rate Charge and Discharge Cycle-Life Characteristics

A constant current experiment regarding the coin cell according to Comparative Example 1 and Examples 1 to 3 was performed by using a charge and discharge apparatus capable of controlling a constant current/a positive potential at 25° C. Herein, the coin cells were applied with a constant current by changing the constant current at a 0.2-0.5-1-2-3-5 C rate with reference to capacity of each coin cell, and a discharge (delithiation) cut-off voltage and a charge (lithiation) cut-off voltage were respectively fixed at 3.0 V (vs. Li/Li+) and 0.005 V (vs. Li/Li+).

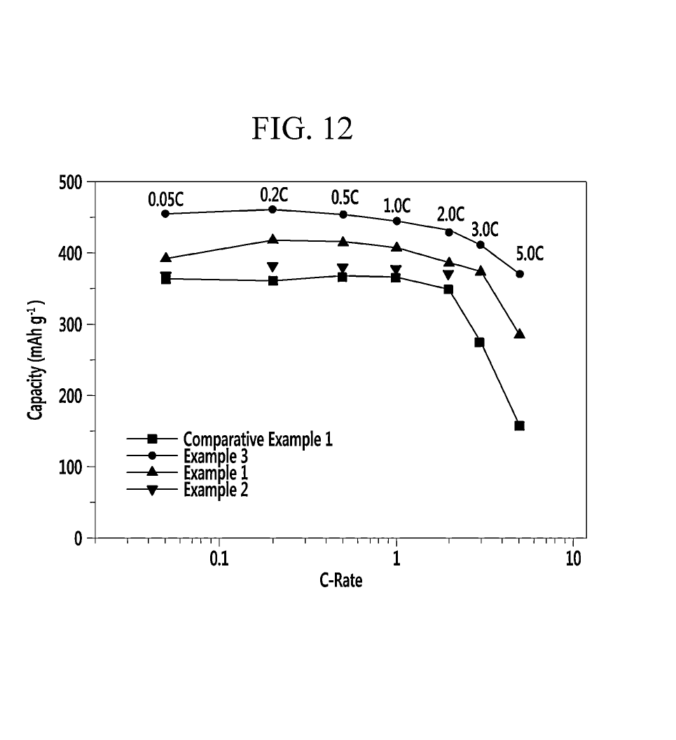

FIG. 12 is a graph showing rate charge and discharge cycle-life characteristics of the cells according to Comparative Example 1 and Examples 1 to 3.

The negative active material having no ATO as a shell showed capacity retention of 43% at 5C relative to the first cycle (0.2C), while the natural graphite negative active material (Example 1) having 15% of ATO as a shell (NG: ATO=10:1) showed capacity retention of 73% at 5C.

In addition, the negative active material having an amorphous carbon layer (Example 3) (NG: ATO=10:1, with citric acid) showed the highest capacity retention of 81% at 5C.

As a result, the natural graphite negative active material having ATO as a shell showed excellent rate characteristics in terms of electrical conductivity and capacity compared with a negative active material not modified into a core-shell structure.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims. Therefore, the aforementioned embodiments should be understood to be exemplary but not limiting the present invention in any way.

What is claimed is:

1. A negative active material for a rechargeable lithium battery, comprising
a core including a material being capable of intercalating and deintercalating lithium ions and a shell positioned on the surface of the core,
wherein the shell comprises antimony-doped tin oxide.

2. The negative active material of claim 1, wherein the antimony-doped tin oxide is coated with carbon or is not coated with carbon.

3. The negative active material of claim 1, wherein the shell further comprises carbon.

4. The negative active material of claim 1, wherein the shell further comprises amorphous carbon.

5. The negative active material of claim 1, wherein the shell comprises a first shell including the antimony-doped tin oxide and a second shell including carbon.

6. The negative active material of claim 1, wherein the shell has a thickness of about 10 nm to about 500 nm.

7. The negative active material of claim 1, wherein the shell is included in an amount of about 5 to about 25 wt % based on the total amount of the negative active material.

8. The negative active material of claim 1, wherein the material being capable of intercalating and deintercalating lithium ions comprises a carbon-based material, an alloy-based material, a metal oxide-based material, or a combination thereof.

9. The negative active material of claim 1, wherein the material being capable of intercalating and deintercalating lithium ions comprises natural graphite, artificial graphite, soft carbon, hard carbon, carbon fiber, carbon nanotubes, carbon nanofiber, graphene, or a combination thereof.

10. The negative active material of claim 1, wherein the material being capable of intercalating and deintercalating lithium ions is an alloy or an oxide of a metal selected from silicon, tin, germanium, antimony, bismuth, or a combination thereof.

11. A method of manufacturing a negative active material for a rechargeable lithium battery, comprising:
preparing a material being capable of intercalating and deintercalating lithium ions;
preparing a shell composition including antimony-doped tin oxide;
adding the material being capable of intercalating and deintercalating lithium ions and the shell composition in a solvent to obtain a mixture; and
heat-treating the mixture.

12. The method of claim 11, wherein the preparation of a material being capable of intercalating and deintercalating lithium ions further comprises activation of the surface of the material being capable of intercalating and deintercalating lithium ions.

13. The method of claim 11, wherein the preparation of a shell composition including the antimony-doped tin oxide comprises coating the antimony-doped tin oxide with carbon.

14. The method of claim 11, wherein the shell composition comprises the antimony-doped tin oxide and a carbon precursor.

15. The method of claim 14, wherein the carbon precursor is sucrose, citric acid, glucose, agarose, polysaccharide, poly(vinyl pyrrolidone), polyvinyl alcohol, or a combination thereof.

16. The method of claim 11, wherein the shell composition is comprised in an amount of about 5 to about 25 wt % based on the total amount of the negative active material for a rechargeable lithium battery.

17. The method of claim 11, wherein the solvent is water, alcohol, acetone, tetrahydrofuran, cyclohexane, carbon tetrachloride, chloroform, methylenechloride, dimethylformamide, dimethylacetamide, dimethylsulfoxide, N-methylpyrrolidone, or a combination thereof.

18. The method of claim 11, wherein the heat-treating is performed at about 400° C. to about 700° C., and for about 1 hour to about 6 hours.

19. The method of claim 11, wherein the heat-treating is performed under an inactive gas atmosphere.

20. A rechargeable lithium battery, comprising:
the negative electrode including a negative active material of claim 1;
a positive electrode; and
an electrolyte.
